(19) United States
(12) Patent Application Publication
(10) Pub. No.: US 2009/0166030 A1
(43) Pub. Date: Jul. 2, 2009

(54) Method to monitor reservoir fracture development and its geometry

(75) Inventors: Oleg Nikolaevich Zhuravlev, Moscow (RU); Dmitry Anatolevich Koroteev, Moscow (RU); Marwan Charara, Moscow (RU)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: Schlumberger Technology Corporation, Cambridge, MA (US)

(21) Appl. No.: 12/341,394

(22) Filed: Dec. 22, 2008

Related U.S. Application Data
(60) Provisional application No. 61/015,746, filed on Dec. 21, 2007.

(30) Foreign Application Priority Data
Dec. 21, 2007 (RU) 2007147227

(51) Int. Cl. E21B 47/00; E21B 43/26; G01V 3/00

(52) U.S. Cl. 166/250.1

(57) ABSTRACT

Method to monitor reservoir fracture development and its geometry may find its application at oil and gas fields as well as in coal mining industry. The method provides injection of conductive fracturing fluid into the wellbore under pressure enabling to create a fracture in the formation and penetrate into it. At the stage corresponding to the end of the fracturing fluid charging a series of voltage pulses is applied to the fracturing fluid. In the well parameters of the electromagnetic field and/or acoustic signals resulting from applying the voltage pulses to the fracturing fluid are measured, and the fracture tip coordinates are determined.

### BACKGROUND OF INVENTION

1. Field of Invention

The invention is related to the methods of reservoir fracture development and its geometry, particularly, by measuring electromagnetic or acoustic field emitted at the end and at the edges of the fracture. The invention may find its application at oil and gas fields as well as in coal mining industry.

2. Background of the Invention

Reservoir fracture is a well-known method to intensify hydrocarbons production from the well by increasing the productive formation bottom-hole area permeability at the expense of fracture formation. Besides, the fracturing is used to improve the water and steam headers' capacity, or as a method of the rock pre-conditioning (splitting the formation into large pieces), e.g. in coal-mining industry.

During the reservoir fracturing water or high-viscosity liquid (also known as fracturing fluid) containing proppant is pumped into the formation in order to make a fracture in the productive range and fill the fracture with the proppant. For efficient application the fracture must be located within the productive range and must not protrude into the adjacent strata, it must also be long and wide enough. Therefore, monitoring over the fracture development and dimensions is a critical stage in the fracturing process optimization assurance.

Currently the fractures' geometry is determined using various techniques and methodologies. Most widely known are methods (the so-called fracturing visualization) ensuring the assessment of the fracture spatial orientation and its length during the fracturing activities, and applying mostly seismic phenomena localization using passive acoustic emission. Other methods are based on stratigraphic dipmeter tool measurement of the insignificant soil deformation either from the surface, or from the wellbore. Another method is pressure buildup curve method consisting in the pressure drop curves analysis during the production.

All these methods are rather expensive due to the necessity of the detectors' proper positioning in the set location considering the relevant mechanical link between the formation and the instruments. Other methods allow an approximate evaluation of the fracture height near the well by either temperature fluctuations or by the data obtained using isotropic tracers. The visualization methods above are reviewed, e.g., in: Barree R. D., Fisher M. K. and Woodroof R. A. (2002) A practical Guide to Hydraulic Fracture Diagnostic Technologies, SPE proceedings, paper 77442, represented at SPE Annual Technical Conference and Exhibition, San Antonio, Tex., Sep. 19-Oct. 2, 2002.

The closest prototype of the method claimed is the method to monitor reservoir fracture development and its geometry described in U.S. Pat. No. 6,330,914 and providing the use of minimum one well, injection of conductive fracturing fluid under pressure allowing the said fluid to create a fracture around the well and penetrate into it and then, across the fracture surfaces—into the filtration zone in the formation around the fracture; application of electrical voltage to the fracturing fluid, subsequent measurement of induced electromagnetic field parameters used (in case of changes) to judge about the fracture development and geometry.

This method has a number of obvious drawbacks. First of all, the use of low-amplitude 100 Hz electric signals entails an artificial signal-to-noise ratio reduction during amplitude measurements which affects the measurement accuracy. Besides, the method described may be applied only on shallow wells and the proposed measurement data processing method to evaluate the fracture geometry is rather complicated.

### DETAILED DESCRIPTION OF THE PREFERRED EMBODIMENTS

Technical result of the invention claimed consists in the creation of an efficient method to monitor the reservoir fracture development and its geometry ensuring a high accuracy and being rather simple. The method provides injection of conductive fracturing fluid into the wellbore under pressure allowing the said fluid to create a fracture in the formation and penetrate into it and then, across the fracture surfaces—into the filtration zone in the formation around the fracture, during the fracturing an application of a series of voltage pulses to the fracturing fluid, subsequent measurement of the parameters of the electromagnetic field and/or acoustic signals resulting from the pulses' application to the fracturing fluid at the stage corresponding to the fracturing fluid charging finish and determination of the fracture tip coordinates.

Voltage pulses are applied to the fracturing fluid using two electrodes one of which contacts the fracturing fluid (or casing pipe), the other is grounded at the distance sufficient to avoid fast discharge of “fracturing fluid-grounded electrode” system due to the generation of sufficient conduction current between the fluid and the electrode in the first moments after the well voltage pulse arrival. In the time interval when the “grounded electrode-well hydraulic fracture” system charging is finished and the current has not begun to flow across the formation, electric and acoustic fields are measured using a distributed detectors system. According to: Landau, Lifshitz “Electrodynamics of Continuous Media”, Nauka, Moscow (2001), sharp end “tip” of the fracture ensures maximum contribution in the total intensity of the fields measured. According to these data, using known methodologies of emission source coordinates recovery based on distributed detectors system data the location of the fracture end and its dimensions are determined (see, e.g., R. D. Barree, M. K. Fisher, R. A. Woodroof “A Practical Guide to Hydraulic Fracture Diagnostic Technologies”, SPE Annual Technical Conference and Exhibition, Sep. 29-Oct. 2, 2002, San Antonio, Tex., paper No. 77442-MS, F. Peterman, D. L. McCarley, K. V. Tanner, J. H. Le Calvez, W. D. Grant, C. F. Hals, L. Bennett, J. C. Palacio “Hydraulic-Fracture Monitoring as a Tool To Improve Reservoir Management”, SPE Production Operations Symposium, Apr. 16-19, 2005, Oklahoma City, Okla., paper No. 94048-MS.

Measurement of the parameters of electromagnetic field and/or acoustic signals resulting from the application of voltage pulses to the fracturing fluid during the fracturing process is performed in at least one well. The measurements may be performed in any well including the one in which hydraulic fracturing is present, the detectors in this case may be located both on the surface or in the well.

One of the invention implementation scenarios provides using at least two wells, with electric and/or acoustic detectors distributed along the measurement well depth at the level close to the fracture level.

To measure the parameters of the electromagnetic field and acoustic signals standard detectors are used which are well known to experts in this area.

Electric field localization effect in the areas with a strong geometric non-uniformity is known. A strong field in “concentrated” around sharp surfaces of conductive charged conductors and on the interfaces between substances with different electric properties. In the case under consideration mildly conducing formation and highly conducting fluid (gel) are used. In case of applying an electrical pulse to the fluid (gel) a high-intensity electric field is observed on the interface, especially on the fracture sharp tip. These areas may be sources of electromagnetic and acoustic emission captured by the relevant detectors. The detectors may be positioned on the surface or in the well (to improve signal-to-noise ratio). Analyzing signals from different detectors it is possible to determine fracture end coordinates and some of its geometric parameters.

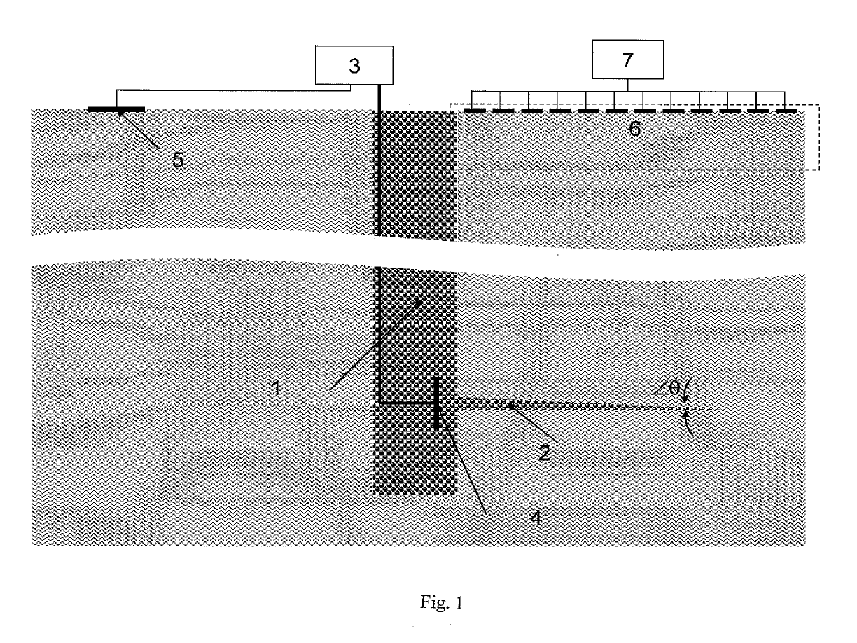

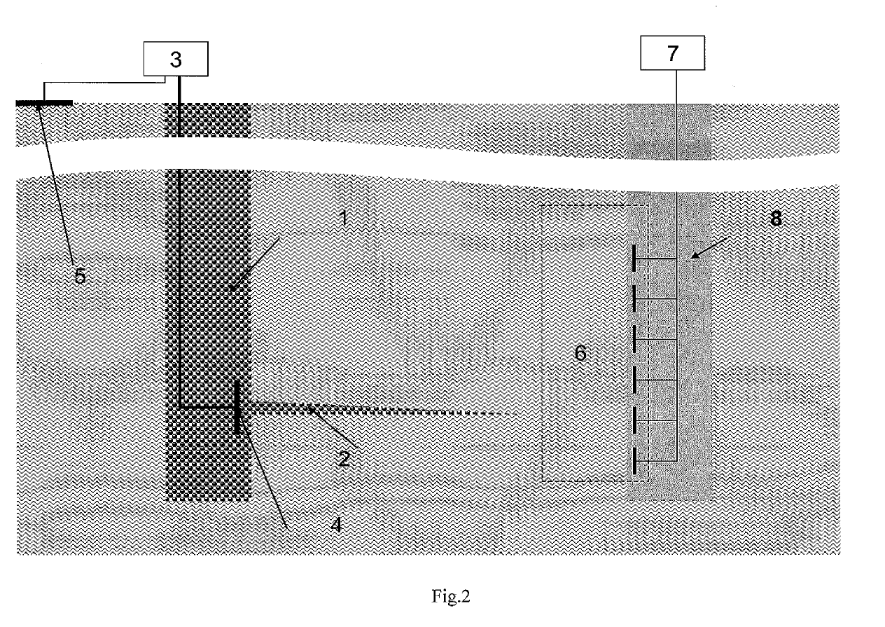

The invention is clarified with drawings in these drawings for vertical well (the any number of wells is possible), FIG. 1 shows the option of the method implementation to determine the fracture parameters during the fracturing process and FIG. 2 shows the method implementation option in case of performing measurements in the measurement well.

The claimed method of the reservoir fracture parameters determination may be implemented as follows.

During the implementation of the fracture parameters determination method conductive fracturing fluid is injected with the pump (not shown) into the wellbore 1. The fracturing fluid is in general a water- or oil-, or surface-active-substance-based high-viscosity structured or non-polymer fluid. Water-based fluids (polymer or surface-active ones) are extremely preferable, or even mandatory to optimize the effect, in gas-producing wells. The fracturing fluid is injected under pressure, high enough to ensure the reservoir fracturing, thus ensuring the fluid movement in well 1. The fracturing fluid pressure value enables its creating fracture 2 around well 1 and penetrating into the filtration zone around the fracture in the productive formation across the fracture. From generator 3 voltage pulse is supplied, it is applied between electrode 4, positioned in well 1 and contacting the fracturing fluid (or casing pipe—not shown), and electrode 5, grounded at a distance from well 1, sufficient top avoid fast discharge of “fracturing fluid—grounded electrode” system due to significant conduction current generation between the fluid and the electrode in the first moments of time after the arrival of the voltage pulse from the well. The voltage pulse value is selected depending on well 1 depth. Fracture “tip” starts intensively emit electromagnetic and acoustic waves which are captured by the set of relevant detectors 6, connected to data collection and processing system 7, that may be positioned on the ground surface (as shown in FIG. 1) or in the measurement well 8 (as shown in FIG. 2).

The amplitude of potential φ change in point A may be evaluated based on the following equation:

$${•}_{A} • • ( \frac{{k}_{w}}{d} ln ( \frac{{R}_{w}}{d} ) • \frac{{k}_{f}}{{d}_{f}} ln ( \frac{{R}_{f}}{{d}_{f}} ) • \frac{k}{R } ) ,$$

where d is the well diameter, R is the distance from the fracture tip to point A (potential measurement point), d_{f} is characteristic linear dimension (thickness) of the fracture near the point of its contact with the well, R_{f} is the shortest distance from the fracture to point A, k_{w}, k_{f} and k are proportionality coefficients of contributions from the well, fracture surface and fracture “tip”, σ is the surface charge density proportional to the voltage applied. It is known (see, e.g., Landau, Lifshitz “Electrodynamics of Continuous Media”) that for tips with a small tapering angle θ, k>>k_{w}, k_{f}. The latter correlation mathematically expresses the fact of increased power emission at the fracture tip which enables monitoring its development and geometry (including in on-line mode) by means of using known methodologies of emission source coordinates recovery based on the data from the distributed detectors system. The pulse application and measurement data processing intervals may vary depending on the desirable intervals of the fracture geometry data obtaining.

1. Method to monitor reservoir fracture development and its geometry, including the use at least one well, injection of conductive fracturing fluid in the well of one of the wells under pressure enabling the fracturing fluid to create a fracture in the formation and penetrate into it and further across the fracture surfaces—the filtration zone around the fracture, application of electric voltage to the fracturing fluid during the fracturing process, measurement of induced electromagnetic field parameters and determination of the fracture geometry, characterized in the fact that a series of voltage pulses is applied to the fracturing fluid at the stage corresponding to the end of the fracturing fluid charge, at least in one well parameters of the electromagnetic field and/or acoustic signals resulting from applying the voltage pulses to the fracturing fluid are measured, and the fracture tip coordinates are determined.

2. Method to monitor reservoir fracture development and its geometry according claim 1 characterized by the fact that the voltage pulses are applied to the fracturing fluid between the electrodes one of which contacts the fracturing fluid, the other is grounded at the distance sufficient to avoid fast discharge of “fracturing fluid-grounded electrode” system due to the generation of sufficient conduction current between the fluid and the electrode in the first moments after the well voltage pulse arrival.

3. Method to monitor reservoir fracture development and its geometry according claim 1 characterized by the fact that the electromagnetic field and/or acoustic signals parameters are measured using an automatic system for the collection and processing of the data from detectors distributed along the well depth or on the surface.

4. Method to monitor reservoir fracture development and its geometry according claim 1 characterized by the fact that at least two wells are used, in one of which fracturing is performed and the other is used to measure the parameters of the electric field and/or acoustic signals resulting from the application of a series of pulses to the fracturing fluid, the measurements are performed at the level close to the level of the fracture resulting from the reservoir fracturing.
